(19) United States
(12) Patent Application Publication
(10) Pub. No.: US 2025/0246072 A1
(43) Pub. Date: Jul. 31, 2025

(54) INDUCTIVE-LOOP VEHICLE DETECTION SYSTEM HAVING BALANCED LINE TRANSCEIVER FOR SENSING INDUCTANCE CHANGES CAUSED BY PASSAGE OR PRESENCE OF VEHICLES

(71) Applicant: CLEARVIEW INTELLIGENCE LTD., Milton Keynes (GB)

(72) Inventor: Steven Richard TEAL, Brackley, Northamptonshire (GB)

(73) Assignee: CLEARVIEW INTELLIGENCE LTD., Milton Keynes (GB)

(21) Appl. No.: 18/281,120

(22) PCT Filed: Mar. 9, 2022
(86) PCT No.: PCT/IB2022/052106

§ 371 Date: Sep. 8, 2023

Related U.S. Application Data
(60) Provisional application No. 63/159,000, filed on Mar. 10, 2021.

(51) Int. Cl. G08G 1/042; G01V 3/10

(52) U.S. Cl. CPC G08G 1/042; G01V 3/10

(57) ABSTRACT

An inductive-loop detection system for detecting a passage or presence of a metallic object includes a tank circuit and a transceiver. The tank circuit has an inductive wire loop. The transceiver is configured to transmit an electric pulse signal to the tank circuit. The tank circuit in response to receiving the electric pulse signal generates an electric response signal which (i) oscillates at a base frequency while no vehicle is near the inductive wire loop and (ii) oscillates at an increased frequency while a vehicle is near the inductive wire loop. The transceiver is further configured to receive the electric response signal to detect therefrom the electric response signal oscillating at the increased frequency whereby the passage or presence of the metallic object is detected.

### CROSS-REFERENCE TO RELATED APPLICATIONS

This application claims the benefit of U.S. Provisional Application No. 63/159,000, filed Mar. 10, 2021, the disclosure of which is hereby incorporated in its entirety by reference herein.

### TECHNICAL FIELD

The present invention relates to inductive-loop vehicle detection systems for detecting the passage or presence of vehicles. More particularly, the present invention relates to methods and systems for sensing inductance changes of an inductive wire loop of an inductive-loop vehicle detection system, caused by the passage or presence of a vehicle over the inductive wire loop.

### BACKGROUND

Inductive-loop vehicle detection systems, or inductive-loop traffic detectors, are used to detect vehicles passing or arriving at a certain point, for instance, approaching a traffic light or in motorway traffic. Inductive-loop vehicle detection systems generate information specifying the presence or absence of a vehicle at a particular location. For example, inductive-loop vehicle detection systems are used at intersections to supply information used by an associated traffic controller to control the operation of the traffic signal heads, to supply control information used in conjunction with automatic entrance and exit gates in parking lots, garages, and buildings, to supply information used for monitoring vehicle traffic volume, etc. In general, inductive-loop vehicle detection systems can be used for a variety of purposes including counting vehicular traffic, arrival notifications, turning on driveway lighting, etc.

An inductive-loop vehicle detection system includes an inductive wire loop. The inductive wire loop is an insulated, electrically conducting loop. The inductive wire loop is installed at a given area within the pavement of a roadway. For instance, the inductive wire loop is installed within the pavement of a traffic lane to be used for detecting vehicles in that traffic lane. The inductive-loop vehicle detection system may include additional inductive wire loops installed within the pavement of other adjacent traffic lanes for detecting vehicles in those traffic lanes.

The inductive-loop vehicle detection system further includes a capacitor. The capacitor in combination with the inductive wire loop form a parallel tuned circuit (“tank circuit”). The tank circuit has a resonant frequency dependent upon the capacitance of the capacitor and the inductance of the inductive wire loop. Particularly, the resonant frequency of the tank circuit is inversely proportional to both the capacitance of the capacitor and the inductance of the inductive wire loop.

Commonly, the inductive-loop vehicle detection system further includes an oscillator. The oscillator provides AC (alternating current) electrical energy to the tank circuit. The tank circuit is part of the oscillator. That is, the oscillator is an LC oscillator whose inductance (L) component is the inductive wire loop and whose capacitance (C) component is the capacitor.

The tank circuit being energized with the AC electrical energy from the oscillator resonates at a resonant frequency. The resonant frequency has a “base” frequency value while no vehicle, or other metallic object, is in the presence of the induction wire loop. The energized inductive wire loop generates a magnetic field. A vehicle passing or stopping over the inductive wire loop physically interacts with the magnetic field. This physical interaction causes the inductance of the inductive wire loop to decrease. As the resonant frequency is inversely proportional to the inductance of the inductive wire loop, the reduction in the inductance causes the resonant frequency of the tank circuit to increase.

The inductive-loop vehicle detection system further includes a monitor for monitoring the resonant frequency of the tank circuit. As the resonant frequency is increased due to the passage or presence of a vehicle over the inductive wire loop, detection of the increased resonant frequency is indicative of the passage or presence of a vehicle over the inductive wire loop. The monitor thereby detects a vehicle upon detecting the increased resonant frequency of the tank circuit.

The capacitor may have a fixed or tunable capacitance value. Elaborate configurations have several available capacitors which can be selectively grouped together by a mechanical switch or software control with an electronic switch. The purpose of this is to change the capacitance value of the tank circuit and thereby tune the resonant frequency of the tank circuit to some particularly desired base frequency. One reason for tuning the tank circuit is that relatively large or relatively small inductive wire loops may otherwise have a resonant frequency that exceeds limits in terms of electromagnetic compliance. Another reason for tuning the tank circuit concerns the situation where the inductive wire loop is installed near another inductive wire loop. When two inductive wire loops are close together and connected to different electronic units, their resonant frequencies must be tuned to be at least several kilohertz apart or ‘beating’ will occur, resulting in reduced performance and false detections.

Further, due to the low-impedance of the inductive wire loop and the high-impedance nature of the oscillator, a matching transformer is required. Such a matching transformer is generally a custom wound part.

In many applications, an inductive-loop vehicle detection system includes a plurality of inductive wire loops. For instance, the inductive-loop vehicle detection system may have respective inductive wire loops for serving different traffic lanes and/or may have pairs of inductive wire loops in same traffic lanes. A pair of inductive wire loops in a same traffic lane are spaced apart so that the flight-time and therefore the speed of vehicles traveling along the traffic lane can be measured.

As such, in many applications, there will be multiple inductive wire loops which will require monitoring. Because of interference and extra processing electronics required, it is desirable to only have a single inductive wire loop oscillating at any one time. This is achieved by multiplexing. Some multiplexing designs have respective oscillators for the inductive wire loops. The oscillators are switched on and off and, in turn, the ‘digital’ outputs from the oscillators are multiplexed to a single frequency measurement unit using a digital multiplexer IC.

Most multiplexing designs, however, have a single oscillator for all of the inductive wire loops. The inputs from the inductive wire loops are multiplexed with an analog multiplexer. This decreases the components required in that only one set of tuning capacitors are needed and, in some cases, only a single matching transformer is needed. Care must be taken using a single oscillator to prevent measurements from one inductive wire loop affecting measurements from the other inductive wire loops. For this reason, the oscillator must be shut down between inductive wire loops and the associated capacitors fully discharged.

### SUMMARY

An object of the present invention is to provide an alternative means to measure an inductance change that occurs when a metallic object, such as a vehicle, passes an inductive sensor, such as an inductive wire loop of an inductive-loop vehicle detection system.

Similarly, an object of the present invention is to provide an alternative means to sense inductance changes of an inductive wire loop of an inductive-loop vehicle detection system caused by the passage or presence of vehicles over the inductive wire loop.

An inductive-loop detection system for detecting the passage or presence of metallic objects (e.g., vehicles, scooters, motorcycles, bicycles, motorized bicycles, tricycles, other wheeled vehicles, etc. (“vehicle” or “vehicles”)) is disclosed. The inductive-loop detection system includes a transceiver and a tank circuit having an inductive wire loop. The transceiver is configured to transmit an electric pulse signal to the tank circuit. The tank circuit in response to receiving the electric pulse signal generates an electric response signal which (i) oscillates at a base frequency while no vehicle is near the inductive wire loop and (ii) oscillates at an increased frequency while a vehicle is near the inductive wire loop. The transceiver is further configured to receive the electric response signal to detect therefrom the electric response signal oscillating at the increased frequency whereby the passage or presence of a vehicle is detected. Preferably, the transceiver is a balanced line transceiver.

The transceiver may be further configured to receive the electric response signal to detect therefrom the electric response signal oscillating at the base frequency whereby it is detected that no metallic object is passing or present.

The inductive-loop detection system may further include a second tank circuit having a second inductive wire loop. In this case, the transceiver is further configured to transmit a second electric pulse signal to the second tank circuit. The second tank circuit in response to receiving the second electric pulse signal generates a second electric response signal which (i) oscillates at a second base frequency while no vehicle is near the second inductive wire loop and (ii) oscillates at a second increased frequency while a vehicle is near the second inductive wire loop. The transceiver is further configured to receive the second electric response signal to detect therefrom the second electric response signal oscillating at the second increased frequency whereby the passage or presence of a metallic object is detected.

Another inductive-loop detection system for detecting the passage or presence of metallic objects (e.g., vehicles) is provided. This inductive-loop detection system includes a transceiver, a capacitor, and an inductive wire loop. The capacitor and the inductive wire loop in combination form a parallel tuned circuit (“tank circuit”). The tank circuit resonates at a resonant frequency. The resonant frequency of the tank circuit is inversely proportional to an inductance of the inductive wire loop. The inductance of the inductive wire loop is decreased while a vehicle is near the inductive wire loop. Therefore, the resonant frequency of the tank circuit is increased while a vehicle is near the inductive wire loop.

The transceiver, preferably a balanced line transceiver, is configured to transmit an electric pulse signal to the tank circuit to energize the tank circuit with electrical energy. The tank circuit being energized with the electrical energy generates an electric response signal which oscillates at the resonant frequency of the tank circuit. The electric response signal therefore oscillates at an increased frequency while a vehicle is near the inductive wire loop. The transceiver is further configured to receive the electric response signal from the tank circuit and to detect from the received electric response signal the resonant frequency of the tank circuit whereby the transceiver detects the passage or presence of a vehicle when the resonant frequency of the tank circuit is increased.

Another inductive-loop vehicle detection system having a transceiver, a tank circuit with an inductive wire loop, and a controller is provided. The transceiver is preferably a balanced line transceiver. The tank circuit has a resonant frequency which increases from a base frequency value to an increased frequency value while a vehicle is in the presence of the inductive wire loop. That is, the resonant frequency has the base frequency value while no vehicle, or other metallic object, is in the presence of the inductive wire loop and has the increased frequency value while a vehicle is in the presence of the inductive wire loop.

The transceiver is configured to transmit an electric pulse signal to energize the tank circuit with electrical energy. The tank circuit being energized with the electrical energy generates an electric response signal which oscillates at the resonant frequency of the tank circuit. The transceiver is further configured to receive the electric response signal from the tank circuit. The controller detects that no vehicle is in the presence of the inductive wire loop when the electric response signal oscillates at the base frequency value and detects that a vehicle is in the presence of the inductive wire loop when the electric response signal oscillates at the increased frequency value.

The transceiver may be further configured to transform the received electric response signal into a digitized electric response signal having a plurality of pulses oscillating at a frequency corresponding to the frequency of the received electric response signal. In this case, the controller may be further configured to implement either a gated high frequency counting process or a time to digital converter counting process to count the number of pulses of the digitized electric response signal in order to measure the frequency of the digitized electric response signal to thereby detect whether a vehicle is in the presence of the inductive wire loop. The controller may be further configured to detect a health status of the inductive wire loop as a function of a total number of the plurality of pulses of the digitized electric response signal.

The controller may be further configured to set a configurable duration of the electric pulse signal. In this case, the controller may set the configurable duration of the electric pulse signal depending on the resonant frequency of the tank circuit.

The inductive-loop vehicle detection system may further include a second tank circuit having a second inductive wire loop. The second tank circuit has a resonant frequency which increases from a second base frequency value to a second increased frequency value while a vehicle is in the presence of the second inductive wire loop. The transceiver is further configured (i) to transmit a second electric pulse signal to energize the second tank circuit with electrical energy whereby the second tank circuit generates a second electric response signal which oscillates at the resonant frequency of the second tank circuit and (ii) to receive the second electric response signal from the second tank circuit. The controller is further configured to detect that no vehicle is in the presence of the second inductive wire loop when the second electric response signal oscillates at the second base frequency value and to detect that a vehicle is in the presence of the second inductive wire loop when the second electric response signal oscillates at the second increased frequency value. The controller may be further configured to set different durations of the electric pulse signals.

### BRIEF DESCRIPTION OF THE DRAWINGS

FIG. 1 illustrates a perspective view showing a typical inductive-loop vehicle detection system installation in accordance with embodiments of the present invention;

FIG. 2 illustrates a block diagram of an inductive-loop vehicle detection system in accordance with embodiments of the present invention, the inductive-loop vehicle detection system including a transceiver and a tank circuit having an inductive wire loop;

FIG. 3 illustrates a schematic, circuit diagram of one embodiment of the inductive-loop vehicle detection system;

FIG. 4 illustrates a first graph having a plot of an electric pulse signal transmitted from the transceiver to the tank circuit, a second graph having a plot of an electric response signal generated by the tank circuit in response to being energized with the electric pulse signal, and a third graph having a plot of a digitized output of the electric response signal;

FIG. 5 illustrates an exemplary first graph having a plot of the received pulses of the digitized output of the electric response signal when the inductance of the inductive wire loop is at a normal inductance level (i.e., when no vehicle is near the inductive wire loop) and an exemplary second graph having a plot of the received pulses of the digitized output of the electric response signal when the inductance of the inductive wire loop is lower than the normal inductance level (i.e., when a vehicle is near the inductive wire loop);

FIG. 6 illustrates an exemplary oscilloscope screen shot having a plot of the electric pulse signal transmitted from the transceiver to the tank circuit, a plot of the electric response signal generated by the tank circuit in response to being energized with the electric pulse signal, and a plot of the digitized output of the electric response signal;

FIG. 7A illustrates a block diagram concerning a gated high frequency counting method for measuring the frequency of the digitized output of the electric response signal generated by the tank circuit in response to being energized with the electric pulse signal;

FIG. 7B illustrates an exemplary oscilloscope screen capture of the signals associated with the gated high frequency counting method;

FIG. 8A illustrates a block diagram concerning a time to digital converter counting method for measuring the frequency of the digitized output of the electric response signal generated by the tank circuit in response to being energized with the electric pulse signal;

FIG. 8B illustrates an exemplary oscilloscope screen capture of the signals associated with the time to digital converter counting method;

FIG. 9 illustrates a block diagram concerning the transmitter section of the transceiver;

FIG. 10A illustrates an exemplary graph having a plot of electric pulse signal width vs. number of generated pulses of the electric response signal;

FIG. 10B illustrates an exemplary oscilloscope screen capture of the signals associated with an excessively long drive pulse;

FIG. 11 illustrates representative formulas for calculating the Q factor (quality factor) of the inductive wire loop;

FIG. 12 illustrates a block diagram of inductive-loop vehicle detector system having an 8-loop count classifier design;

FIG. 13A illustrates a graph showing the effect of temperature on measured frequency for the inductive-loop vehicle detector system;

FIG. 13B illustrates a graph of measured frequency of the inductive-loop vehicle detector system taken while a bicycle was ridden over an inductive wire loop;

FIG. 13C illustrates a graph of measured frequency of the inductive-loop vehicle detector system taken while a passenger vehicle was driven over two inductive wire loops;

FIG. 13D illustrates a graph of measured frequency of the inductive-loop vehicle detector system taken while an articulated lorry (e.g., a truck) was driven over two inductive wire loops; and

FIG. 13E illustrates a graph of counted received pulses of the inductive-loop vehicle detector system taken while an articulated lorry was driven over two inductive wire loops.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

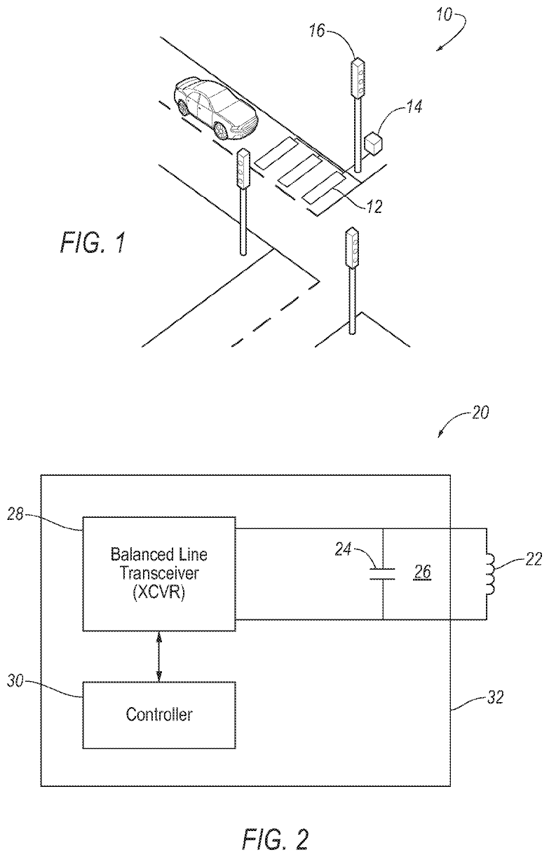

Referring now to FIG. 1, a perspective view showing a typical inductive-loop vehicle detection system installation 10 is shown. The inductive-loop vehicle detection system includes at least one inductive wire loop 12 buried just below a road surface. The ends of inductive wire loop 12 are returned to a vehicle detector of the inductive-loop vehicle detection system. The vehicle detector is usually housed some distance away in a controller cabinet 14. A decrease in the inductance of inductive wire loop 12 occurs when a vehicle passes or is positioned over the inductive wire loop. The decrease in inductance is sensed by the vehicle detector which outputs a signal to indicate the presence of a vehicle. For instance, the vehicle detector outputs the signal to a traffic controller for the traffic controller to control a traffic light 16 accordingly.

Referring now to FIG. 2, a block diagram of an inductive-loop vehicle detection system 20 in accordance with embodiments of the present invention is shown. Inductive-loop vehicle detection system 20 is operable for detecting the passage or presence of metallic objects in the form of vehicles. Alternatively, or additionally, inductive-loop vehicle detection system 20 may be a more general inductive-loop detection system operable for detecting the passage or presence of other types of metallic objects such as scooters, motorcycles, bicycles, etc.

Inductive-loop vehicle detection system 20 includes an inductive wire loop 22 and a capacitor 24. Inductive wire loop 22 is installed at a given area within the pavement of a roadway. Capacitor 24 in combination with inductive wire loop 22 form a parallel tuned circuit (“tank circuit”) 26. Tank circuit 26 has a resonant frequency. The resonant frequency of tank circuit 26 is inversely proportional to both the inductance of inductive wire loop 22 and the capacitance of capacitor 24. The inductance of inductive wire loop 22 is decreased while a vehicle is near (e.g., passing over or in the presence of) inductive wire loop 22. Consequently, the resonant frequency of tank circuit 26 has (i) a base frequency value while no vehicle is near inductive wire loop 22 and (ii) an increased frequency value while a vehicle is near inductive wire loop 22.

Inductive-loop vehicle detection system 20 further includes a transceiver 28. Transceiver 28 is connected in series with tank circuit 26. Transceiver 28 is configured to transmit an electric pulse signal to tank circuit 26 to energize tank circuit 26 with electrical energy. Tank circuit 26 being energized with the electrical generates an electric response signal which oscillates at the resonant frequency of tank circuit 26. The electric response signal therefore oscillates (i) at the base frequency value while no vehicle is near inductive wire loop 22 and (ii) at the increased frequency while a vehicle is near inductive wire loop 22. Transceiver 28 is further configured to receive the electric response signal from tank circuit 26.

Inductive-loop vehicle detection system 20 further includes a controller 30. Controller 30 is an electronic hardware device such as a computer or processor. Controller 30 is operable to control operation of transceiver 28. For example, controller 30 is operable to control when transceiver 28 transmits the electric pulse signal (e.g., rate of periodicity) and/or the duration of the electric pulse signal.

Controller 30 is configured to monitor the electric response signal from tank circuit 26 received by transceiver 28. Controller 30 monitors the electric response signal to detect therefrom the resonant frequency of tank circuit 26. Controller 30 generates a first type of output signal signifying that no vehicle is near inductive wire loop 22 when the resonant frequency of tank circuit 26, as deduced from the electric response signal, has the base frequency value. As the resonant frequency of tank circuit 26 will have the base frequency value when no vehicle is near inductive wire loop 22, the first type of output signal is therefore proper. Conversely, controller 30 generates a second type of output signal signifying that a vehicle is near inductive wire loop 22 when the resonant frequency of tank circuit 26, as deduced from the electric response signal, has the increased frequency value. As the resonant frequency of tank circuit 26 will have the increased frequency value when a vehicle is near inductive wire loop 22, the second type of output signal is therefore proper.

Controller 30 transfers the output signal to another controller, such as a traffic light controller to control traffic lights accordingly, a physical gate controller to control entrance and exit gates, a traffic controller for vehicle volume monitoring, etc.

As noted, inductive wire loop 22 is installed within the pavement of a roadway. Capacitor 26 and transceiver 28 are housed within a device housing 32. Controller 32 may also be housed within device housing 32, as shown in FIG. 2. Alternatively, controller 32 is located remotely from device housing 32 and communicates via wired or wireless communications with transceiver 28.

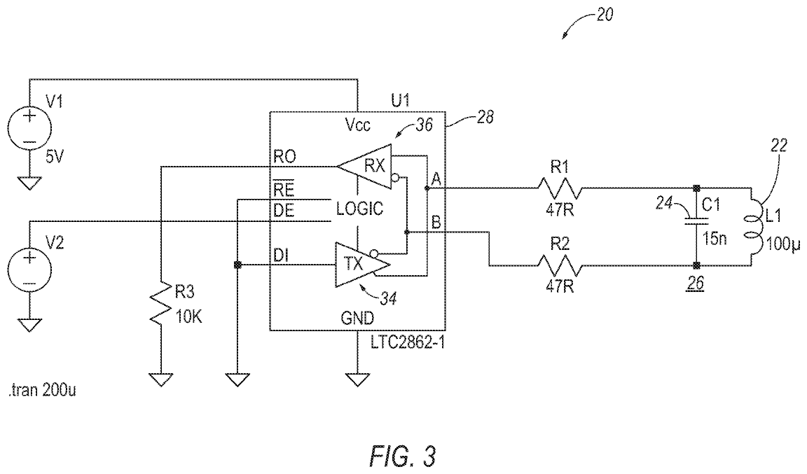

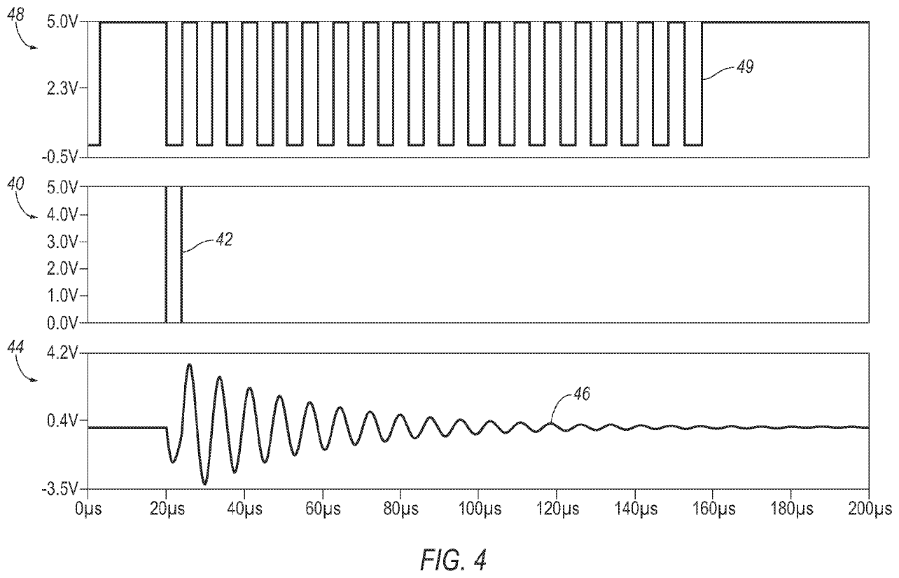

As described, in accordance with embodiments of the present invention, transceiver 28 is used to measure the resonant frequency of tank circuit 26. Preferably, as will now be described with reference to FIG. 3, transceiver 28 is a balanced line transceiver.

Referring now to FIG. 3, with continual reference to FIG. 2, a schematic, circuit diagram of inductive-loop vehicle detection system 20 is shown. As shown in FIG. 3, transceiver 28 is a balanced line transceiver. Balanced line transceivers are often used to convey digital information between two or more stations in a half-duplex fashion over single twisted pair cable. By being a balanced line transceiver, transceiver 28 includes a transmitter section, generally designated with reference numeral 34, and a receiver section, generally designated with reference numeral 36. Transmitter section 34 and receiver section 36 are each connected to the transmission line connected to tank circuit 26 with two terminals commonly referred to as ‘A’ and ‘B’ (labeled accordingly in FIG. 3).

Transceiver 28 can operate either as a transmitter, via transmitter section 34, or as a receiver, via receiver section 36. When operating in the transmitter mode, transmitter section 34 actively drives the ‘A’ and ‘B’ lines at opposing polarities determined by the state of a digital input terminal. When operating in the receive mode, the output drivers are set to high-impedance mode and receiver section 36 outputs a digital output according to the voltage difference on the A and B terminals.

Transceiver 28 is a single transceiver that can be used with multiple inductive wire loops. Transceiver 28 replaces the typical twisted pair cable with a parallel tuned circuit as shown in FIG. 3.

In FIG. 3, L1 represents inductive wire loop 22, C1 represents tuning capacitor 24, and U1 represents balanced line transceiver 28. Resistors R1 and R2 are current limiting resistors. A voltage source V1 (for example, 5V voltage source) provides power to the circuit. Receiver section 36 is enabled by grounding the RE (receiver enable) terminal. The driver is enabled by controlling a voltage source V2 which transmits a logical ‘0’ onto the A and B terminals when set high.

Referring now to FIG. 4, with continual reference to FIGS. 2 and 3, the operation of a representative circuit of inductive-loop vehicle detection system 20 will be described. Initially, FIG. 4 illustrates a first graph 40 having a plot 42 of an electric pulse signal transmitted from transmitter section 34 to tank circuit 26, a second graph 44 having a plot 46 of an electric response signal generated by tank circuit 26 in response to being energized with the electric pulse signal, and a third graph 48 having a plot 49 of a digitized output of the electric response signal.

The circuit of inductive-loop vehicle detection system 20 functions as follows. A logical high-level electric pulse of a predetermined duration is applied to the drive enable pin (DE) of transceiver 28. For instance, the predetermined duration is 4 μS. The driver portion of transceiver 28 becomes active for the duration of the electric pulse and drives tank circuit 26 with a low-impedance source of 5V from voltage supply V1. That is, transmitter section 34 transmits an electric pulse signal (i.e., a drive pulse) having a pulse width of the predetermined duration (e.g., 4 μS) and a voltage of 5V. Plot 42 of first graph 40 represents the electric pulse signal. The electric pulse signal charges (i.e., energizes) tank circuit 26.

At the end of the electric pulse signal, the logical low signal applied to the DE pin of transceiver 28 disables the driver, leaving the A and B outputs in a high-impedance state. Tank circuit 26, now being unimpeded, ‘rings’ with a gradually diminishing sinewave (i.e., the electric response signal which is the analog signal across tank circuit 26) represented by plot 46 of second graph 44. That is, tank circuit 26 generates the electric response signal in response to being energized with the electric pulse signal. Plot 46 of second graph 44 represents the electric response signal.

As can be seen by plot 46 of second graph 44, the diminishing sinewave electric response signal oscillates at a frequency. The frequency of the electric response signal is the resonant frequency of tank circuit 26. The frequency of tank circuit 26 depends on the value of the value of the inductance (L1) of inductive wire loop 22 and the capacitance (C1) of capacitor 24 with the standard LC resonate frequency formula:

$$f = 1 / ( 2 * π * √ ( LC ) )$$

Receiver section 36 is active all the time and gives a ‘digitized’ output of the analog signal on the A-B terminals while tank circuit 26 is ringing. That is, receiver section 36 gives a digitized output of the electric response signal. This digitized output is shown in plot 49 of third graph 48.

As shown in plot 46 of second graph 44, the sinusoidal electric response signal of tank circuit 26 diminishes over time. The rate at which the electric response signal diminishes is determined by the ‘Q’ or quality factor of the inductor (i.e., Q factor of inductive wire loop 22). The higher the Q factor the longer the ringing takes to diminish. When the peak-peak value of the ringing drops below an amplitude threshold of receiver section 36, the receiver section no longer produces digitized output pulses (shown in plot 49 of third graph 48) and instead outputs a steady high output (also shown in plot 49 of third graph 48). Therefore, the number of pulses seen at the digitized output of receiver section 36 can be used to gauge the Q factor of inductor wire loop 22.

Controller 30 measures the frequency of the received pulses of the digitized output of receiver section 36. Controller 30 uses the measured frequency of the received pulses of the digitized output of receiver section 36 to determine the inductance of inductive wire loop 22 (particularly, to determine (i) whether the inductance of the inductive wire loop is at a normal inductance level thereby indicating that no vehicle is near the inductive wire loop or (ii) whether the inductance of the inductive wire loop is lower than a normal inductance level thereby indicating that a vehicle is near the inductive wire loop).

The frequency of the received pulses of the digitized output of receiver section 36 will be at a base frequency level when the inductance of inductive wire loop 22 is at the normal inductance level. As a vehicle passes over inductive wire loop 22, the inductance of the inductive wire loop will reduce causing the frequency of the received pulses of the digitized output of receiver section 36 to increase. Accordingly, the frequency of the received pulses of the digitized output of receiver section 36 will be greater than that of a base frequency level when the inductance of inductive wire loop 22 is lower than the normal inductance level.

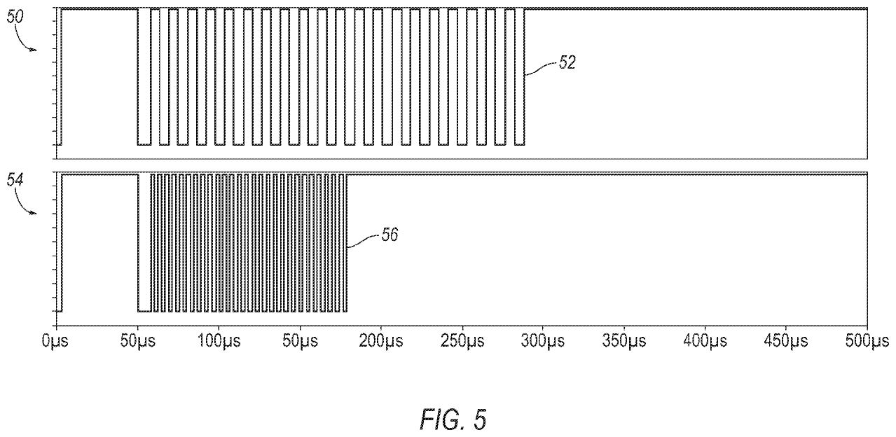

FIG. 5 illustrates an exemplary first graph 50 having a plot 52 of the received pulses of the digitized output of receiver section 36 when the inductance of inductive wire loop 22 is at the normal inductance level (i.e., when no vehicle is near the inductive wire loop) and an exemplary second graph 54 having a plot 56 of the received pulses of the digitized output of receiver section 36 when the inductance of inductive wire loop 22 is lower than the normal inductance level (i.e., when a vehicle is near the inductive wire loop). Second graph 54 in comparison with first graph 50 illustrates the effect on frequency of the digitized output of receiver section 36 with a substantial change in inductance of inductive wire loop 22; plot 56 of second graph 54 is associated with a lower inductance than plot 52 of first graph 50 and therefore has a greater frequency than plot 52 of first graph 50.

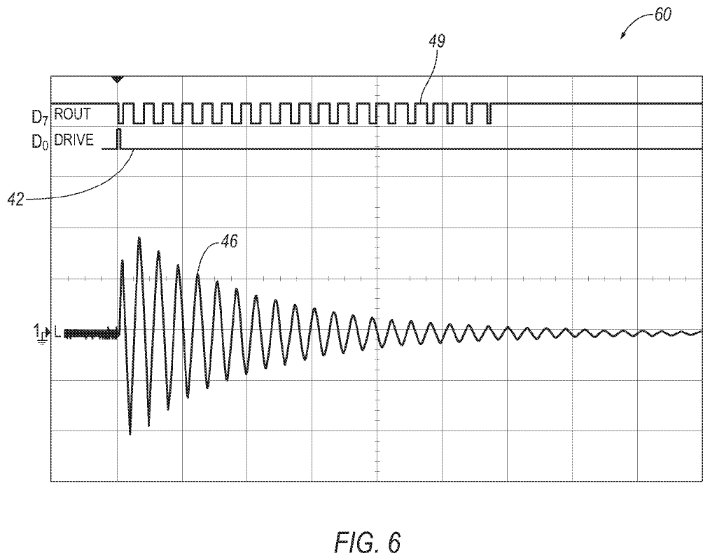

With reference to FIG. 4, FIG. 6 illustrates an exemplary oscilloscope screen shot 60 having plot 42 of the electric pulse signal transmitted from transceiver to tank circuit, plot 46 of the electric response signal generated by tank circuit 26 in response to being energized with the electric pulse signal, and plot 49 of the digitized output of the electric response signal. Exemplary oscilloscope screen shot 60 are results obtained from testing the simulated circuit shown in FIG. 3 on real hardware.

### Frequency Measurement

In operation, after obtaining the digitized output (e.g., plot 49 of FIGS. 4 and 6) from receiver section 36 of the electric response signal (e.g., plot 46 of FIGS. 4 and 6) generated by tank circuit 26 in response to being energized with the electric pulse signal (e.g., plot 42 of FIGS. 4 and 6) from transmitter section 34, the next step is to measure the frequency of the digitized output (i.e., measure the frequency of the pulses received). Different methods will be discussed herein. The methods are readily understandable by those of ordinary skill in the art. The methods measure the time taken for multiple pulses to occur. The number of measurement pulses is configurable and the higher the number of measurement pulses the higher the output resolution will be. However, there is an upper limit since there is a finite number of pulses per measurement cycle.

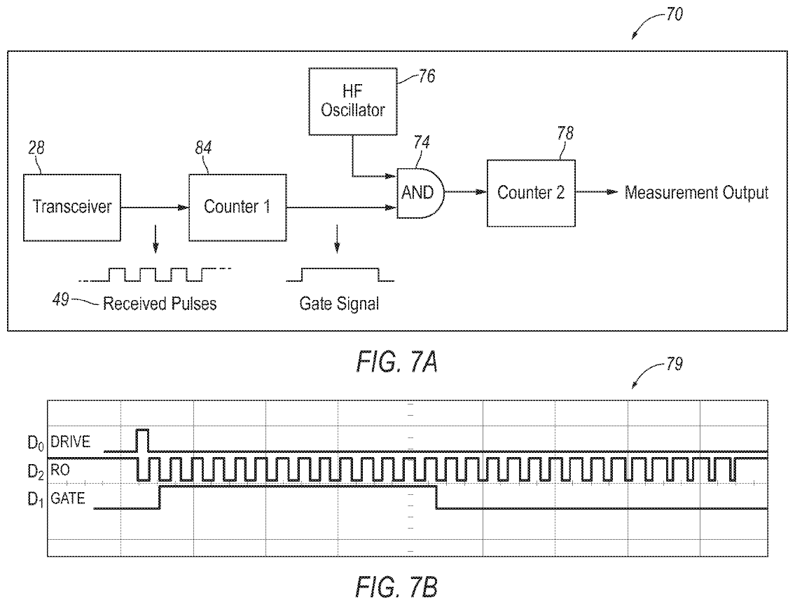

FIG. 7A illustrates a block diagram 70 concerning a gated high frequency counting method for measuring the frequency of the digitized output of the electric response signal. As such, FIG. 7A depicts the basic operation of the gated high frequency measurement technique. The received pulses (e.g., plot 49) from transceiver 28 are used to clock a first counter 72 (“Counter 1”). First counter 72 is configured such that it will produce a logical ‘1’ on its output on the falling edge of the first pulse it sees. First counter 72 will increment with each subsequent falling edge. When first counter 72 reaches a pre-determined value the first counter will set its output to a logical ‘0’ state, where it will remain. The output from first counter 72 is logically AND'ed at an AND circuit 74 with the output from a high frequency oscillator 76. This gives at the output of AND circuit 74 a burst of high frequency pulses which are used to a clock a second counter 78 (“Counter 2”). Both counters 72 and 78 are reset at the start of a measurement cycle. At the end of the measurement cycle, that is, after the output of first counter 72 becomes low, second counter 78 is read. The count value read along with knowledge of the frequency of HF oscillator 76 and the number of measured pulses can be used to determine the frequency of the received pulses. HF oscillator frequency 76 is typically tens of MHz.

FIG. 7B illustrates an exemplary oscilloscope screen shot 79 of the signals associated with the gated high frequency counting measurement. As shown in screen shot 79, the ‘GATE’ signal lasts for thirteen pulses (RO).

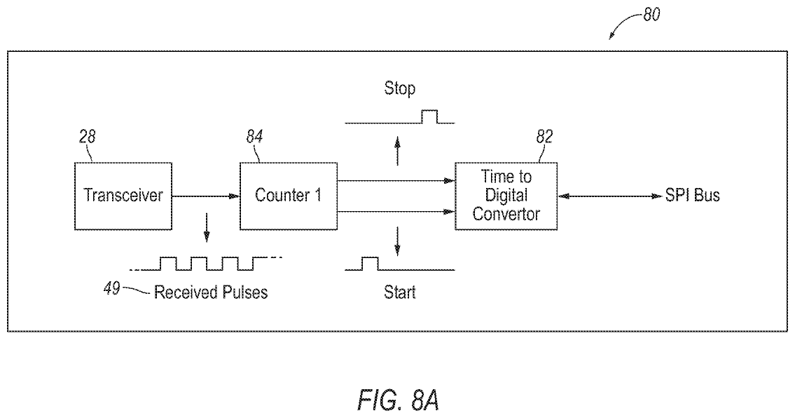

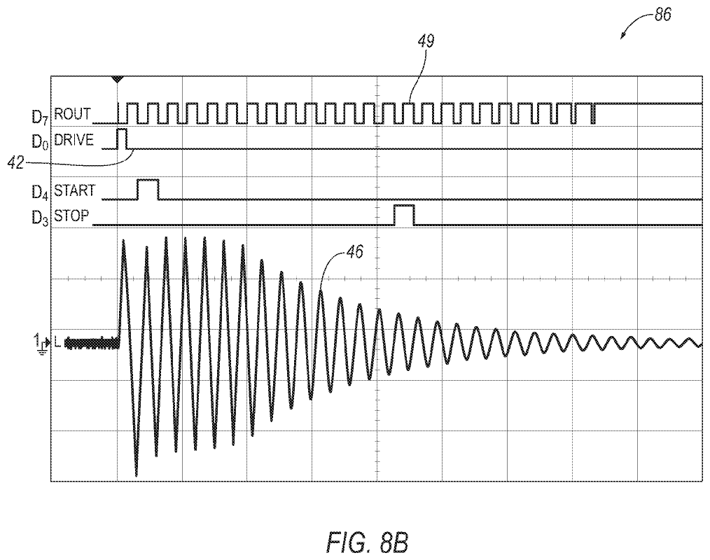

FIG. 8A illustrates a block diagram 80 concerning a time to digital converter counting method for measuring the frequency of the digitized output of the electric response signal. Block diagram 80 shows the operation of a circuit using a Time to Digital Convertor IC (TDC) 82 to measure the elapsed time of several pulses and thus determine the pulse frequency. An example of TDC 82 is the TDC7200 from Texas Instruments. TDC 82 can be considered a digital stopwatch. TDC 82 has a pair of inputs labeled ‘Start’ and ‘Stop’. TDC 82 measures the elapsed time between start and stop to a high level of accuracy and resolution. TDC 82 communicates with a host processor via a SPI bus. This is used for configuration and to retrieve the results of a measurement.

The start and stop signals are generated by a counter 84. Counter 84 generates the start pulse on the first falling edge of the first pulse counter 84 sees. Counter 84 increments with each subsequent falling edge. Counter 84 generates a stop signal when counter 84 reaches a pre-determined value. Both outputs remain low until the end of the measurement cycle, at which point the host processor reads the result from TDC 82 via the SPI bus. This data along with knowledge of the number of pulses that were measured can be used to determine the inductive-loop frequency. After that, counter 84 is reset and TDC 82 prepared via the SPI bus for the next measurement.

The advantage of the Time to Digital Convert against the gated clock design involve problems associated with the high frequency clock. The high frequency required to have a proper resolution with a small number of measurement cycles is several tens of megahertz. This can lead to higher power consumption and EMC compliance issues and present some challenges with crossing-clock domains. Generation of such a high frequency would generally be done with a Phase Locked Loop (PLL) which then may present some stability issues. TDC 82 on the other hand takes care of all these problems internally, with a performance equivalent to a HF oscillator running in the region of 1 GHZ, far exceeding what could be easily achieved with a gated clock system.

FIG. 8B illustrates an exemplary oscilloscope screen shot 86 of the signals associated with the exemplary time to digital converter counting method. As set forth in screen shot 86, there are thirteen pulses between the Start and Stop signals.

### Drive Pulse Generation

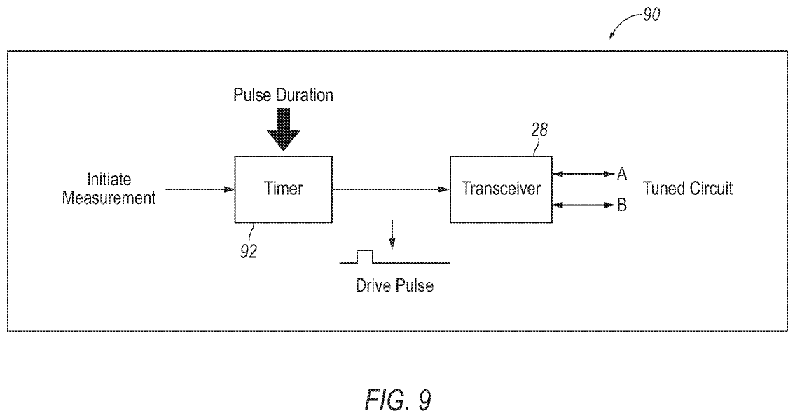

FIG. 9 illustrates a block diagram 90 concerning transmitter section 34 of transceiver 28. Transmitter section 34 can be considered as a driver. The driver is controlled by a ‘Drive Pulse’ generator. The Drive Pulse generator produces a pulse of configurable duration at the onset of a new measurement.

The circuit consists of a timer 92. Timer 92 generates a pulse of configurable width, rather like a ‘monostable flip-flop’, after a trigger or start signal is received. This ‘initiate measurement’ signal is generated by the core logic/host processing system. The duration of the pulse can be set manually, or, more preferably automatically under software control.

The output of timer 92 connects to the ‘Driver Enable’ (DE) input of transceiver 28. When high, transceiver 28 drives the A and B outputs in a logic ‘0’ state. When low, the A/B signal will be in high-impedance tri-state mode. For most applications, an 8-bit timer clocked at 12 MHz is all that is required. This gives an output pulse width range of 83 nS to 21.25 μS in 83 nS steps.

### Drive Pulse Optimization

The length of the drive pulse (i.e., the electric pulse signal) may be important and if so, needs to be considered. If the length of the drive pulse is too short, then too few pulses will be generated. If the length of the drive pulse is too long, then power is wasted, and the sine wave generated by tank circuit 26 can be distorted. Optimal, in this case is the minimum pulse width needed to generate the maximum number of measurement pulses. It could also be considered the minimum pulse width required to generate the required number of pulses, the two may not be same thing.

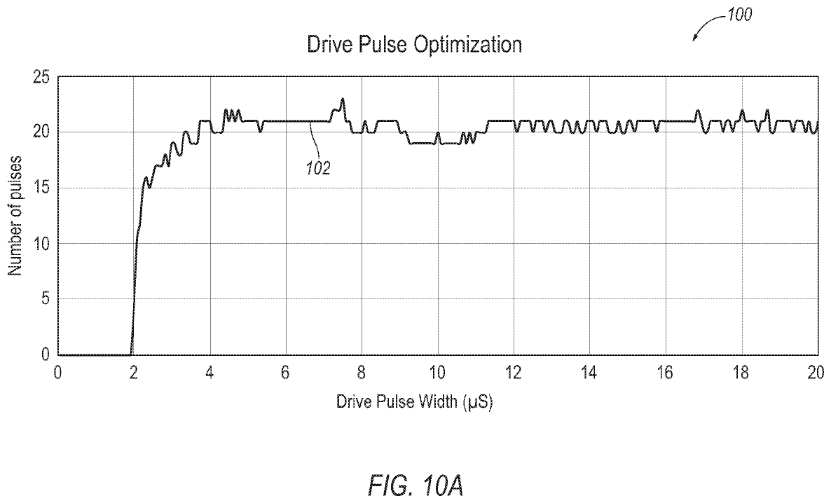

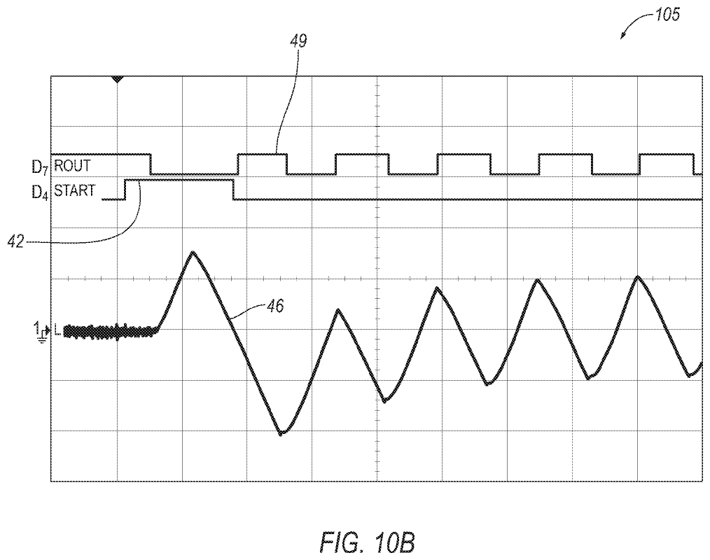

FIG. 10A illustrates an exemplary graph 100 having a plot 102 of the drive pulse width vs. the number of generated pulses of the electric response signal generated by tank circuit 26 in response to being energized with the drive pulse. The results of exemplary graph 100 are from an experiment where the drive pulse width was gradually increased from 0 to 20 μS, and the total number of pulses generated recorded at each step. The subject tank circuit included a 100 μH inductor and a 15 nH capacitor. It is clear from exemplary graph 100 that the number of cycles of the generated electric response signal increases and then levels off as the drive pulse width is increased.

As shown in exemplary graph 100, the point at which the leveling off starts to occur is around 4 μS. This is consistent with the half cycle time of the resonate frequency. The measured resonate frequency of the actual components used was 131.57 kHz. The calculated value is exactly 130 kHz. The difference is explained by component tolerance. The half cycle time of 131.57 kHz is 3.8 μS. Interestingly the number of cycles is maximized at 7.6 μS which is a cycle time of 131.57 khz.

In this case the optimal pulse width is considered 3.8 μS. This gives twenty-one cycles which is very close to a maximum of twenty-three pulses. Software can easily calculate and apply this value by measuring the frequency. Clearly the algorithm would start off at a high pulse width first to establish the frequency first.

FIG. 10B illustrates an exemplary oscilloscope screen capture 105 of the signals associated with an excessively long drive pulse. The effect of an excessively long drive pulse (plot 42) is seen in exemplary oscilloscope screen capture 105. Here, the drive pulse is approximately twice the optimal value. An effect is that the resulting analog signal generated across tank circuit 26 (plot 46) is a distorted signal reassembling a triangle wave instead of a sine wave.

### ‘Q’ Factor Influences

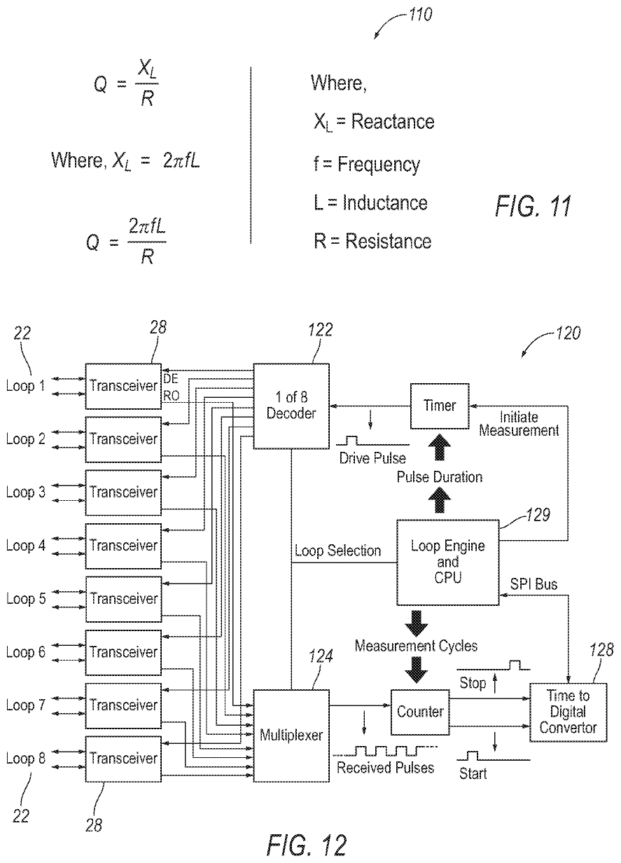

The Quality (Q) factor of inductive wire loop 22 is a measure of how close inductive wire loop is to an ideal inductor, i.e., an inductor having no parasitic resistance. The Q factor is calculated with the formulas shown in FIG. 11.

With an optimized drive pulse, the Q factor directly influences the total of number of pulses seen on the receiver output of transceiver 28. This value can be used to determine health of inductive wire loop 22 and may give an early warning of a failure of inductive wire loop 22.

An alternative use for the total number of cycles could be used for axle detection as the effective Q factor will reduce when wheels or axles pass over with an optimized inductive wire loop.

### Multi-Loop System Design

FIG. 12 illustrates a block diagram of FIG. 12 of inductive-loop vehicle detector system 20 having an 8-loop count classifier design. Here, inductive-loop vehicle detector system 20 has eight pairs of inductive wire loops 22 and transceivers 28. That is, inductive-loop vehicle detector system 20 has a transceiver per loop input. The remaining components of inductive-loop vehicle detector system 20 are shared or multiplexed between the loops such that only one loop can be activated at any one time.

A single drive pulse timer is connected to a ‘1 of 8’ decoder 122. Decoder 122 activates the drive enable (DE) input of transceiver 28 corresponding to inductive wire loop 22 currently being measured. In the same way, a multiplexer 124 selects the receive out (RO) signal and routes this to a counter 126 to generate the stop and start pulses for time-to-digital converter 128 to measure. The entire process is managed by a core logic system and central processor (CPU) 129. This allows great flexibility, for example each inductive wire loop 22 can have different drive pulse width and measurement cycle settings.

### Power Consumption

Power consumption of the loop detection electronics, but not of the complete system, will now be discussed. Further, the power consumed is mainly determined by the specification of the selected transceiver and therefore this should only serve as an example.

The transceiver selected for evaluation and testing is the ST3485 from ST Microelectronics. This is a low cost, low power RS485 transceiver having the following specifications with respect to power consumption.

| State | Max supply current | |
|---|---|---|
| Shutdown | 1 | μA |
| Receiver enabled | 1.9 | mA |
| Receiver and driver | 2.2 | mA |
| enabled (no load) | | |

The supply current to a ST3485 was measured, with the driver and receiver enabled, connected to a load comprising two 47Ω series resistors and a 100 uH inductor in parallel with a 15 nF capacitor. The current was 41.25 mA.

Given a system scanning eight inductive wire loops sequentially every 1 mS, and a drive pulse of 4 μS:

Every 625 μS: one transceiver 28 will be driving the load at 41.25 mA for 4 μS, for the remaining 6214 μS, only receiver section 36 of this transceiver will be enabled at 1.9 mA. The remaining seven transceivers will be shutdown adding 7 μA.

The total power required for transceivers 28 is calculated as 2.85 mA.

There are further ways that power can be saved, for example by turning off receiver sections 36 after the prescribed number of pulses have been received.

### Advantages

Inductive-loop vehicle detection system 20 has the following advantages.

First, inductive-loop vehicle detection system 20 requires no transformer for matching the impedance of the circuit to the impedance of inductive wire loop 22. Such a transformer tends to be a custom part, adding additional cost.

Second, inductive-loop vehicle detection system 20 does not have crosstalk between inductive wire loops 22. Because the only common components with the design are the power supply and digital processing electronics, there is no chance of activity on one inductive wire loop 22 affecting the performance of any other of inductive wire loops 22.

Third, inductive-loop vehicle detection system 20 requires no lengthy warm up time. A low power LC oscillator takes time to settle at the resonate frequency. Most loop detector designs allow for several cycles to occur before starting a measurement. This warm-up time adds to overall time it takes to obtain a measurement and restrict the maximum scan time. Moreover, in the time allowed the oscillator does reach the resonate frequency, tests have showed that switching between inductive wire loops can take five seconds to fully reach the resonate frequency. However, generally after about five cycles, the oscillator is stable enough to take repeatable measurements.

With transceiver 28 instead of an oscillator being employed in inductive-loop vehicle detection system 20 there are no warm-up cycles required as soon as the drive pulse is disabled the corresponding inductive wire loop will start oscillating at the resonate frequency.

Fourth, transceiver 28 has inherent protection. That is, transceivers by design are required to connect to long distance cables that can be subjected to surges, bulk-current transients, and electrostatic discharge (ESD). For this reason, transceivers are available with built in protection and there are many examples of external devices that can increase this performance. In addition, the series resistors also help. In contrast, the traditional multiplexed oscillator design requires more care when designing the protection circuit, which can lead to additional BOM cost and compliance challenges.

Fifth, inductive-loop vehicle detection system 20 has improved supply voltage flexibility. A typical oscillator-based design requires a bipolar 5 V supply, requiring additional components. Transceiver 28 can operate at 3.3 V which can be the same supply as the core logic and processing system. This greatly simplifies the power supply and helps keep power consumption to a minimum.

### Test Results

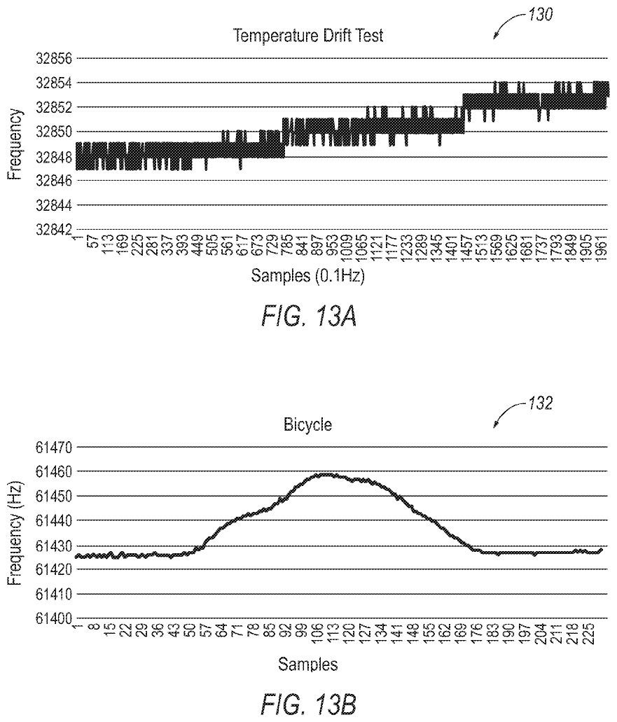

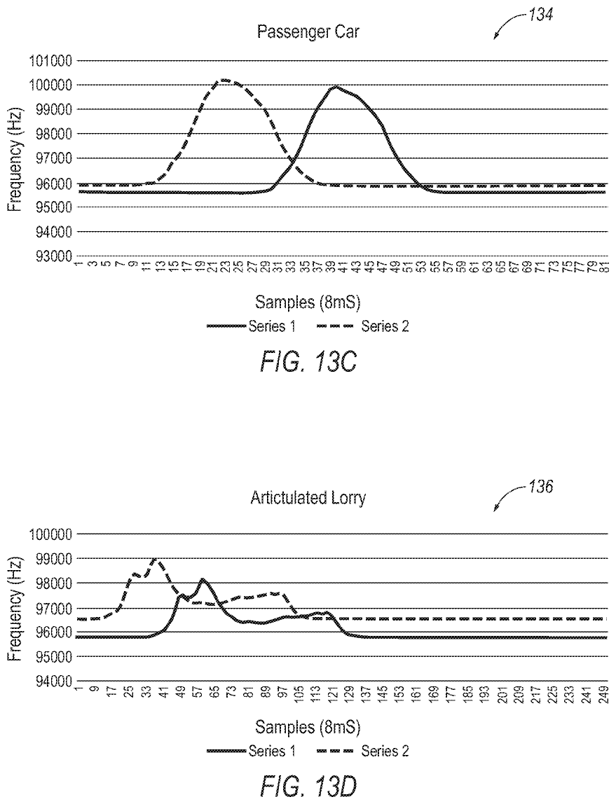

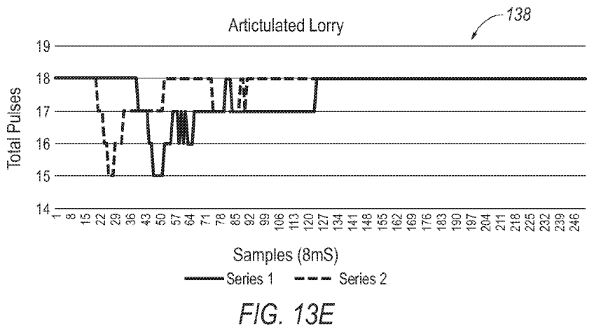

FIG. 13A illustrates a graph 130 that shows the effect of temperature on measured frequency for inductive-loop vehicle detector system 20. A frequency measurement was taken every ten seconds over five and half hours. The ambient temperature increased from 16° C. to 20° C. in this time.

FIG. 13B illustrates a graph 132 of measured frequency of inductive-loop vehicle detector system 20 taken while a bicycle was ridden over inductive wire loop 22. Inductive wire loop 22 in this case is a one square meter inductive wire loop.

FIG. 13C illustrates a graph 134 of measured frequency of inductive-loop vehicle detector system 20 taken while a passenger vehicle was driven over two inductive wire loops 22. Each inductive wire loop 22 in this case is a two square meter inductive wire loop and being separated from one another at a distance of 2.5 m.

FIG. 13D illustrates a graph 136 of measured frequency of inductive-loop vehicle detector system 20 taken while an articulated lorry (e.g., a truck) was driven over two inductive wire loops 22. Each inductive wire loop 22 in this case is a two square meter inductive wire loop and are separated from one another at a distance of 2.5 m.

FIG. 13E illustrates a graph 138 of counted received pulses of inductive-loop vehicle detector system 20 taken while an articulated lorry was driven over two inductive wire loops 22. Each inductive wire loop 22 in this case is a two square meter inductive wire loop and are separated from one another at a distance of 2.5 m. Graph 138 shows how the total number of pulses counted on two inductive wire loops as an articulated lorry is driven over them.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. An inductive-loop detection system for detecting a passage or presence of a metallic object, comprising:
a tank circuit having an inductive wire loop;
a transceiver configured to transmit an electric pulse signal to the tank circuit;
wherein the tank circuit in response to receiving the electric pulse signal generates an electric response signal which (i) oscillates at a base frequency while no vehicle is near the inductive wire loop and (ii) oscillates at an increased frequency while a vehicle is near the inductive wire loop; and
the transceiver is further configured to receive the electric response signal to detect therefrom the electric response signal oscillating at the increased frequency whereby the passage or presence of the metallic object is detected.

2. The inductive-loop detection system of claim 1 wherein:
the transceiver is a balanced line transceiver.

3. The inductive-loop detection system of claim 1 wherein:
the transceiver is further configured to receive the electric response signal to detect therefrom the electric response signal oscillating at the base frequency whereby it is detected that no metallic object is passing or present.

4. The inductive-loop detection system of claim 1 further comprising:
a second tank circuit having a second inductive wire loop;
wherein the transceiver is further configured to transmit a second electric pulse signal to the second tank circuit;
the second tank circuit in response to receiving the second electric pulse signal generates a second electric response signal which (i) oscillates at a second base frequency while no vehicle is near the second inductive wire loop and (ii) oscillates at a second increased frequency while a vehicle is near the second inductive wire loop; and
the transceiver is further configured to receive the second electric response signal to detect therefrom the second electric response signal oscillating at the second increased frequency whereby the passage or presence of a metallic object is detected.

5. The inductive-loop detection system of claim 1 wherein:
the electric pulse signal has a pulse width duration which results in the electric response signal having a decaying sinusoidal waveform including a given number of cycles, wherein the pulse width duration is such that if the pulse width duration was increased the electric response signal would instead have a triangular waveform.

6. The inductive-loop detection system of claim 1 wherein:
the tank circuit further includes a capacitor.

7. The inductive-loop detection system of claim 1 wherein:
the metallic object is a vehicle.

8. The inductive-loop detection system of claim 1 wherein:
the metallic object is a bicycle, tricycle, a scooter, a motorcycle, a motorized bicycle, or a wheeled vehicle.

9. An inductive-loop detection system for detecting a passage or presence of a vehicle, comprising:
a transceiver;
a capacitor;
an inductive wire loop, an inductance of the inductive wire loop being decreased while a vehicle is near the inductive wire loop;
the capacitor and the inductive wire loop in combination form a tank circuit, the tank circuit having a resonant frequency inversely proportional to the inductance of the inductive wire loop whereby the resonant frequency of the tank circuit is increased while a vehicle is near the inductive wire loop;
the transceiver is configured to transmit an electric pulse signal to the tank circuit to energize the tank circuit with electrical energy;
the tank circuit energized with the electrical energy generating an electric response signal which oscillates at the resonant frequency of the tank circuit whereby an electric response signal oscillates at an increased frequency while a vehicle is near the inductive wire loop; and
the transceiver being further configured to receive the electric response signal from the tank circuit and to detect from the received electric response signal the resonant frequency of the tank circuit whereby the transceiver detects the passage or presence of a vehicle when the resonant frequency of the tank circuit is increased.

10. The inductive-loop detection system of claim 9 wherein:
the transceiver is a balanced line transceiver.

11. An inductive-loop vehicle detection system comprising:
a transceiver;
a tank circuit having an inductive wire loop, the tank circuit having a resonant frequency which increases from a base frequency value to an increased frequency value while a vehicle is in a presence of the inductive wire loop;
the transceiver being configured (i) to transmit an electric pulse signal to energize the tank circuit with electrical energy whereby the tank circuit generates an electric response signal which oscillates at the resonant frequency of the tank circuit and (ii) to receive the electric response signal from the tank circuit; and
a controller configured to detect that no vehicle is in the presence of the inductive wire loop when the electric response signal oscillates at the base frequency value and to detect that a vehicle is in the presence of the inductive wire loop when the electric response signal oscillates at the increased frequency value.

12. The inductive-loop vehicle detection system of claim 11 wherein:
the transceiver is a balanced line transceiver.

13. The inductive-loop vehicle detection system of claim 11 wherein:
the transceiver is further configured to transform the received electric response signal into a digitized electric response signal having a plurality of pulses oscillating at a frequency corresponding to the frequency of the received electric response signal.

14. The inductive-loop vehicle detection system of claim 13 wherein:
the controller is further configured to implement a gated high frequency counting process to count a number of pulses of the digitized electric response signal in order to measure the frequency of the digitized electric response signal to thereby detect whether a vehicle is in a presence of the inductive wire loop.

15. The inductive-loop vehicle detection system of claim 13 wherein:
the controller is further configured to implement a time to digital converter counting process to count a number of pulses of the digitized electric response signal in order to measure the frequency of the digitized electric response signal to thereby detect whether a vehicle is in a presence of the inductive wire loop.

16. The inductive-loop vehicle detection system of claim 13 wherein:
the controller is further configured to detect a health status of the inductive wire loop as a function of a total number of the plurality of pulses of the digitized electric response signal.

17. The inductive-loop vehicle detection system of claim 11 wherein:
the controller is further configured to set a configurable duration of the electric pulse signal.

18. The inductive-loop vehicle detection system of claim 17 wherein:
the controller is further configured to set the configurable duration of the electric pulse signal depending on the resonant frequency of the tank circuit.

19. The inductive-loop vehicle detection system of claim 11 further comprising:
a second tank circuit having a second inductive wire loop, the second tank circuit having a resonant frequency which increases from a second base frequency value to a second increased frequency value while a vehicle is in a presence of the second inductive wire loop;
wherein the transceiver is further configured (i) to transmit a second electric pulse signal to energize the second tank circuit with electrical energy whereby the second tank circuit generates a second electric response signal which oscillates at the resonant frequency of the second tank circuit and (ii) to receive the second electric response signal from the second tank circuit; and
the controller is further configured to detect that no vehicle is in the presence of the second inductive wire loop when the second electric response signal oscillates at the second base frequency value and to detect that a vehicle is in the presence of the second inductive wire loop when the second electric response signal oscillates at the second increased frequency value.

20. The inductive-loop vehicle detection system of claim 19 wherein:
the controller is further configured to set different durations of the electric pulse signals.
